(19) United States
(12) Patent Application Publication
(10) Pub. No.: US 2020/0218140 A1
(43) Pub. Date: Jul. 9, 2020

(54) Indoor Intelligent Home Stereo Projector with 360-Degree Rotation

(71) Applicant: Wun Yi So, Hong Kong (HK)

(72) Inventor: Wun Yi So, Hong Kong (HK)

(21) Appl. No.: 16/281,066

(22) Filed: Feb. 20, 2019

(30) Foreign Application Priority Data
Jan. 8, 2019 (CN) 201910013748.8

(51) Int. Cl. G03B 21/14; G03B 21/16; G03B 31/00; H04N 13/363

(52) U.S. Cl. CPC G03B 21/145; G03B 21/16; G03B 21/008; H04N 13/363; G03B 31/00

(57) ABSTRACT

The invention relates to an indoor intelligent home stereo projector with 360-degree rotation which includes a base. The upper end of the base is fixedly connected to a rotating device. The upper end of the rotating device is coupled with a projector body. The projector body is provided with a heat dissipating device. The projector body is screwed with a dustproof device. The outer surface of the projector body is fixedly connected with an illumination lamp. The rotating device includes a support column, a box body, a rotating shaft, a support plate, a magnet column, a through slot, a plug-in board, a motor, a first bevel gear, a second bevel gear, a limiting seat and a limiting strip. The indoor intelligent home stereo projector with 360-degree rotation can realize 360-degree rotation of the projector by using a rotating device. It can be adjusted as needed, which is convenient and quick. The heat dissipating device can avoid excessive temperature to affect the performance of the device when the projector is running.

### FIELD OF THE INVENTION

The invention relates to the technical field of projectors, and in particular to an indoor intelligent home stereo projector with 360-degree rotation.

### BACKGROUND

A projector is a device that can project images or videos onto a screen. It can be connected to a computer, VCD, DVD, BD, game console, DV, etc. through different interfaces to play the corresponding video signals.

With the advancement of technology, smart home projectors came into being, but ordinary projectors have fixed structures, which are not easy to adjust according to needs. The projectors have more integrated components, and the heat dissipation effect is poor, and the performance of the projectors are influenced due to the high temperature.

### SUMMARY OF THE INVENTION

The technical problem to be solved is to overcome the above-mentioned deficiency by providing an indoor intelligent home stereo projector with 360-degree rotation.

To overcome the above technical problem, the present invention provides the following technical solution. An indoor intelligent home stereo projector with 360-degree rotation includes a base. The upper end of the base is fixedly connected to a rotating device. The upper end of the rotating device is coupled with a projector body. The projector body is provided with a heat dissipating device. The projector body is screwed with a dustproof device. The outer surface of the projector body is fixedly connected with an illumination lamp.

The rotating device includes a support column, a box body, a rotating shaft, a support plate, a magnet column, a through slot, a plug-in board, a motor, a first bevel gear, a second bevel gear, a limiting seat and a limiting strip. The upper end of the support column is fixedly connected with a box body. The box body is provided with a through slot. The through slot is slidably connected to the rotating shaft. The plug-in board is slidably inserted into the box body. The motor is fixedly connected in the box body. The end of the shaft of the motor is fixedly connected to the first bevel gear. The first bevel gear is engaged with the second bevel gear. The second bevel gear is slidably coupled to the limiting seat.

The heat dissipating device includes a cover plate, a fan, a ventilation tube, a support ring, a second spring, and a sliding sleeve. The cover plate is fastened to the projector body by a screw, and the fan is fixedly connected to the lower end of the cover plate. The ventilation tube is fixedly connected to the left end of the fan, and a support ring is sleeved on the outer side of the ventilation tube.

The outer side of the ventilation tube is sleeved with a second spring, and the outer side of the ventilation tube is sleeved with a sliding sleeve. The sliding sleeve is slidably sleeved with the projector body.

The dustproof device includes a cylinder body, a ventilation opening, a card slot, a latch, a third spring, a connecting rod, a support piece and a high-efficiency filter net. The cylinder body is screwed to the projector body by threads. The cylinder body is provided with the ventilation opening, the cylinder body is provided with the card slot. The latch is snapped into the card slot. The third spring is sleeved on an outer side of the latch.

Preferably, the rotating shaft is slidably sleeved with the second bevel gear. The rotating shaft is provided with a limiting strip. The limiting strip is slidably sleeved with the second bevel gear. The upper end of the rotating shaft is fixedly connected with a support plate. The magnet column is fixedly connected to the upper end of the support plate.

Preferably, the latch is slidably sleeved with the connecting rod, and a support piece is fixedly connected to the right end of the connecting rod. The support piece is a porous hollow structure, and the high-efficiency filter net is attached to the left end of the support piece.

Preferably, the projector body is provided with a ventilation hole, and the lower end of the projector body is provided with a positioning slot. The positioning slot is slidably connected with the magnet column, and the positioning slot is fixedly embedded with an iron block. The iron block is attracted to the magnet column.

Preferably, the projector body is provided with a projection system. The projection system includes a light source, an optical path system, a digital micromirror system, a control system and a power module. The light source is an LED light source, and the control system includes a processor circuit, a digital image driving circuit and an interface circuit. A signal port of the interface circuit is electrically connected to a signal port of the processor circuit, and a signal input end of the digital image driving circuit is electrically connected to a signal output end of the processor circuit. The light source and the signal input of the digital micromirror system are electrically connected to the signal output of the digital image driving circuit.

Preferably, the interface circuit includes a WIFI module, an HDMI interface, a USB interface, and a decoding circuit.

Preferably, the data port of the processor circuit is connected to the data port of the storage module, and the storage module includes an eMMC memory and a micro SD interface. The data port of the processor circuit is connected to the signal input end of the speaker.

Compared with the prior art, the technical effect of the present invention is as follows. The indoor intelligent home stereo projector with 360-degree rotation can realize 360-degree rotation of the projector by using a rotating device. It can be adjusted as needed, which is convenient and quick. The heat dissipating device can avoid excessive temperature to affect the performance of the device when the projector is running.

### BRIEF DESCRIPTION OF THE DRAWINGS

The invention is illustrated by the following figures and embodiments.

FIG. 1 shows a schematic diagram of whole structure of an indoor intelligent home stereo projector with 360-degree rotation in accordance with an example embodiment.

FIG. 2 shows a section view of a projector body of an indoor intelligent home stereo projector with 360-degree rotation in accordance with an example embodiment.

FIG. 3 shows a section view of a cylinder body of an indoor intelligent home stereo projector with 360-degree rotation in accordance with an example embodiment.

FIG. 4 shows a section view of a box body of an indoor intelligent home stereo projector with 360-degree rotation in accordance with an example embodiment.

FIG. 5 shows a schematic diagram of a support piece of an indoor intelligent home stereo projector with 360-degree rotation in accordance with an example embodiment.

FIG. 6 shows the working principle diagram of the projection system of an indoor intelligent home stereo projector with 360-degree rotation in accordance with an example embodiment.

FIG. 7 shows a top view of a box body of an indoor intelligent home stereo projector with 360-degree rotation in accordance with an example embodiment.

FIG. 8 shows a top view of a rotating shaft of an indoor intelligent home stereo projector with 360-degree rotation in accordance with an example embodiment.

The reference numbers of the figures are as follows:

1: base; 2: rotating device; 21: support column; 22: box body; 29: rotating shaft; 210: support plate; 211: magnet column; 212: through slot; 213: plug-in board; 214: motor; 215: first bevel gear; 216: second bevel gear; 217: limiting seat; 218: limiting strip; 3: projector body; 31: ventilation hole; 32: positioning slot; 33: magnet block; 4: heat dissipating device; 41: cover plate; 42: fan; 43: ventilation tube; 44: support ring; 45: second spring; 46: sliding sleeve; 5: dustproof device; 51: cylinder body; 52: ventilation opening; 53: card slot; 54: latch; 55: third spring; 56: connecting rod; 57: support piece; 58: high-efficiency filter net; 6: illumination lamp.

### DETAILED DESCRIPTION

The invention is illustrated in accordance with figures. The figures as simplified diagrams demonstrate the basic structures of the apparatus of embodiments of the invention. Thus, the invention is not limited to the figures.

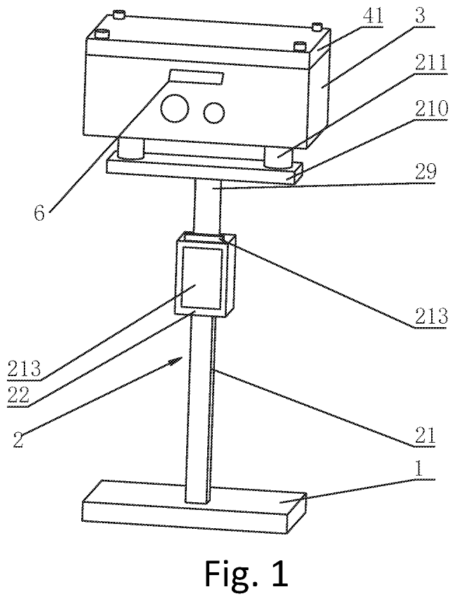

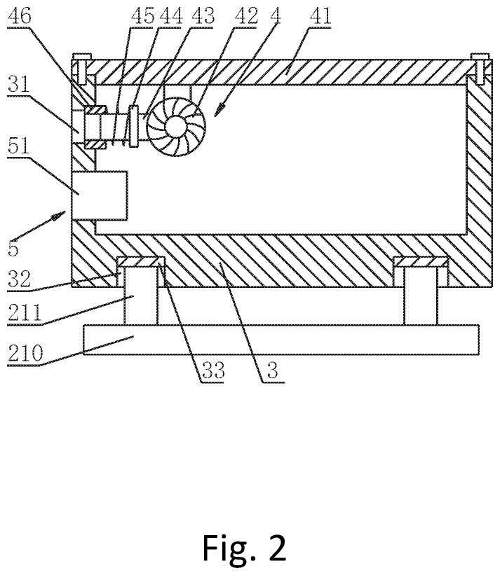

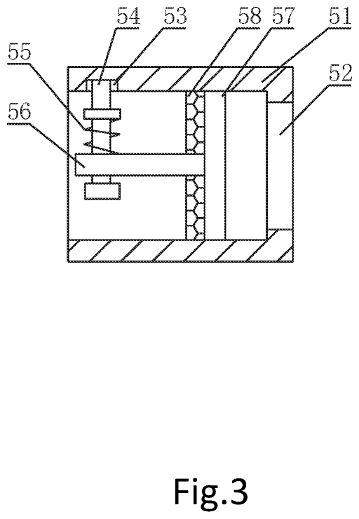

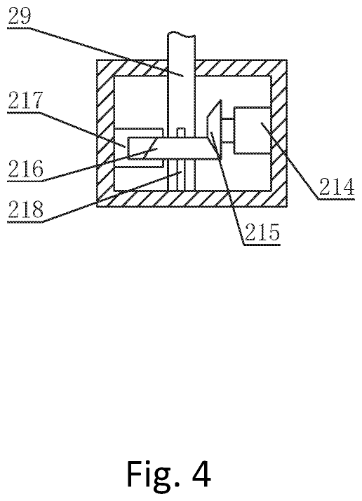

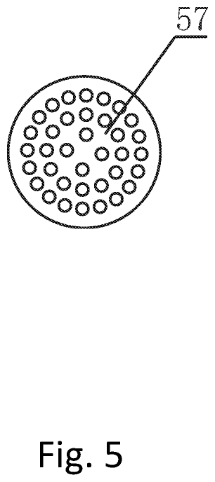

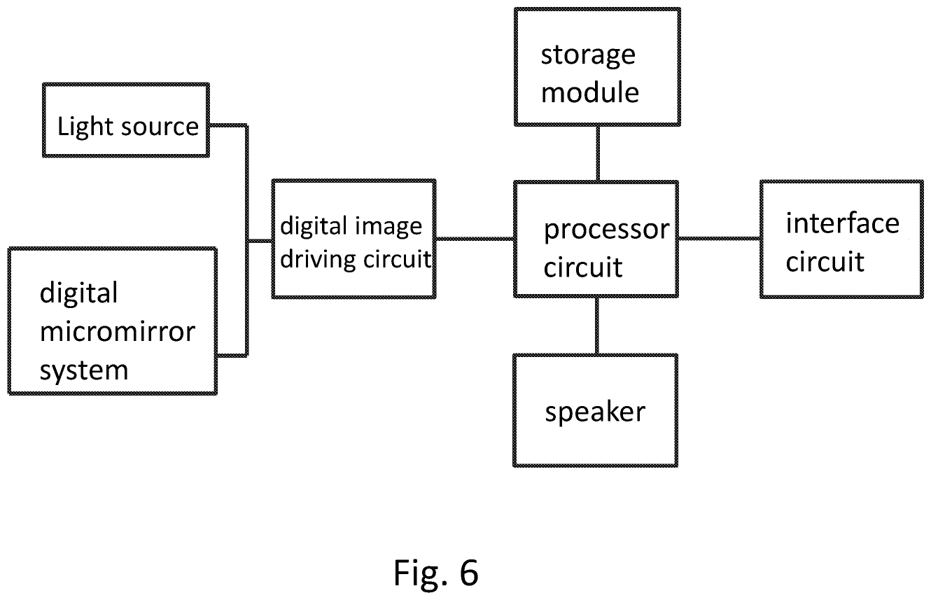

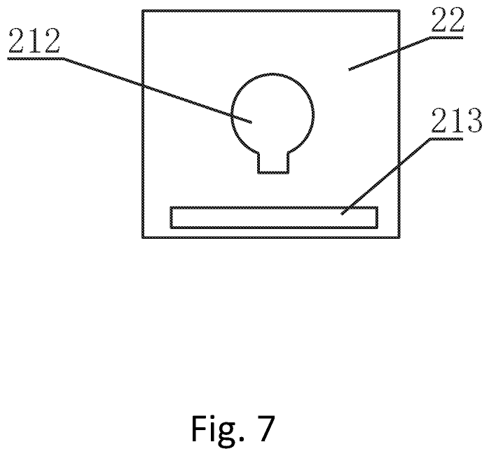

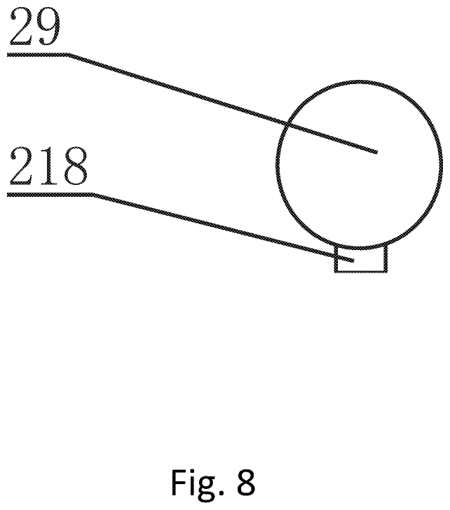

Referring to FIGS. 1-8, the present invention provides the following technical solution. An indoor intelligent home stereo projector with 360-degree rotation includes a base 1. The upper end of the base 1 is fixedly connected to a rotating device 2. The upper end of the rotating device 2 is coupled with a projector body 3. The projector body 3 is provided with a ventilation hole 31 for air circulation, and the lower end of the projector body 3 is provided with a positioning slot 32. The positioning slot 32 is slidably connected with the magnet column 211, and the positioning slot 32 is fixedly embedded with an iron block 33. The iron block 33 is attracted to the magnet column 211, which limits the projector body 3. The back of the projector body 3 is provided with a sensor, the sensor is connected to a controller. The controller is connected to the motor 214. The controller is connected with an external power source, and the position of the user can be tracked by the sensor, so that the projection is always in front of the audiences. The projector body 3 adopts the dual lens design. One is the projection lens of the projector, using the LED light source, 0.45-inch DMD chip, and the other lens is a separate lens with automatic optical focusing and human-computer interaction. The projector body 3 is provided with a projection system. The projection system includes a light source, an optical path system, a digital micromirror system, a control system and a power module. The light source is an LED light source, and the control system includes a processor circuit, a digital image driving circuit and an interface circuit. The interface circuit includes a WIFI module, an HDMI interface, a USB interface, and a decoding circuit for data intercommunication. A signal port of the interface circuit is electrically connected to a signal port of the processor circuit.

The processor model of the processor circuit is quad core Cortex-A9. A signal input end of the digital image driving circuit is electrically connected to a signal output end of the processor circuit. The light source and the signal input of the digital micromirror system are electrically connected to the signal output of the digital image driving circuit. The data port of the processor circuit is connected to the data port of the storage module, and the storage module includes an eMMC memory and a micro SD interface, which can store data. The data port of the processor circuit is connected to the signal input end of the speaker. The speaker outputs audio. The projector body 3 is provided with a heat dissipating device 4. The projector body 3 is screwed with a dustproof device 5. The outer surface of the projector body 3 is fixedly connected with an illumination lamp 6. The illumination lamp 6 is an LED light source, adopting high-end LED high-spec light source P1W, combined with advanced lens optical coating technology, to achieve high transmittance of RGB three-color beam, high brightness and pure color, wide color gamut development technology combined with DLP digital optical processing projection technology to achieve high-performance graphics analysis capabilities, adding intelligent dynamic contrast adjustment.

The rotating device 2 includes a support column 21, a box body 22, a rotating shaft 29, a support plate 210, a magnet column 211, a through slot 212, a plug-in board 213, a motor 214, a first bevel gear 215, a second bevel gear 216, a limiting seat 217 and a limiting strip 218. The upper end of the support column 21 is fixedly connected with a box body 22. The box body 22 is provided with a through slot 212. The through slot 212 is slidably connected to the rotating shaft 29. The rotating shaft 29 can rotate within the through slot 212. The plug-in board 213 is slidably inserted into the box body 22, so that the box body 22 is closed. The motor 214 is fixedly connected in the box body 22. The end of the shaft of the motor 214 is fixedly connected to the first bevel gear 215. The first bevel gear 215 is engaged with the second bevel gear 216. The second bevel gear 216 is slidably coupled to the limiting seat 217. The rotating shaft 29 is slidably sleeved with the second bevel gear 216. The rotating shaft 29 is provided with a limiting strip 218. The limiting strip 218 is slidably sleeved with the second bevel gear 216. The upper end of the rotating shaft 29 is fixedly connected with a support plate 210. The magnet column 211 is fixedly connected to the upper end of the support plate 210, which is used to attract the magnet column 33.

The heat dissipating device 4 includes a cover plate 41, a fan 42, a ventilation tube 43, a support ring 44, a second spring 45, and a sliding sleeve 46. The cover plate 41 is fastened to the projector body 3 by a screw, and the fan 42 is fixedly connected to the lower end of the cover plate 41. The fan 42 and the switch are connected in series with the power source through the wire. The ventilation tube 43 is fixedly connected to the left end of the fan 42, and a support ring 44 is sleeved on the outer side of the ventilation tube 43. The outer side of the ventilation tube 43 is sleeved with a second spring 45, which has compressive and elastic functions, and the outer side of the ventilation tube 43 is sleeved with a sliding sleeve 46. The sliding sleeve 46 is slidably sleeved with the projector body 3.

The dustproof device 5 includes a cylinder body 51, a ventilation opening 52, a card slot 53, a latch 54, a third spring 55, a connecting rod 56, a support piece 57 and a high-efficiency filter net 58. The cylinder body 51 is screwed to the projector body 3 by threads. The cylinder body 51 is provided with the ventilation opening 52 for air circulation, the cylinder body 51 is provided with the card slot 53. The latch 54 is snapped into the card slot 53, which positions the connecting rod 56. The third spring 55 is sleeved on an outer side of the latch 54, which has compressive and elastic functions. The latch 54 is slidably sleeved with the connecting rod 56, and a support piece 57 is fixedly connected to the right end of the connecting rod 56. The support piece 57 is a porous hollow structure for air circulation, and the high-efficiency filter net 58 is attached to the left end of the support piece 57, which can effectively filter the dust.

In the implementation of the present invention, when the projector is in operation, the power module supplies power to the system, and provides a light source to the LED lamp in which the light source is more clear and stable. It controls the system to work, and controls the operation of the digital micro-mirror system. It transmits data to the digital image driving circuit. The image driving circuit causes the image to be projected. The interface circuit provides data input for the system. Under the operation of the processor circuit, the related data is stored by the storage module. While the images are projected, the speaker outputs the audio, thereby realizing the projection effect. When the projector body 3 performs heat dissipation, the switch of the fan 42 is activated, the fan 42 operates, and the air in the projector body 3 is extracted. The air passes through the fan 42, the ventilation tube 43, the sliding sleeve 46 and the ventilation hole 31, and flows out of the projector body 3. The heat is dissipated in time to avoid the excessive temperature affecting the performance. When the air flows out, the air outside the projector body 3 sequentially enters the projector body 3 through the cylinder body 51, the high-efficiency filter net 58, the support piece 57 and the ventilation opening 52 to achieve air circulation. When the air passes through the high-efficiency filter net 58, the dust is filtered to prevent it from entering the projector body 3, and has a dustproof function. When the dust accumulates in the cylinder body 51, the latch 54 is moved downward, and the third spring 55 is compressed. The latch 54 leaves the card slot 53, i.e. the connecting rod 56 can be moved to the left. The support piece 57 slides out along the inner wall of the cylinder body 51, so that the dust can be cleaned quickly and conveniently. When people watch the image, the sensor on the back of the projector body 3 can track the position of the customer, and control the motor 214 to work. When the position of the person changes, the sensor works, the position of the person is tracked. The controller controls the motor 214 to work, the motor 214 rotates, the first bevel gear 215 rotates, and the second bevel gear 216 rotates. Under the action of the limiting strip 218, the rotating shaft 29 rotates in the through slot 212. Since the second bevel gear 216 is limited by the limiting seat 217, the second bevel gear 216 cannot move axially. The rotating shaft 29 drives the support plate 210 to rotate, drives the magnet column 211 to rotate, and drives the projector body 3 to rotate, achieving the adjustment of position, which makes the projection always in front of the audiences. When the rotating shaft 29 needs to be disassembled, the rotating shaft 29 only needs to be moved upward. The rotating shaft 29 is separated from the second bevel gear 216. The rotating shaft 29 leaves from the through slot 212, and separated from the box body 22, i.e. it can be removed easily and quickly disassembled.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An indoor intelligent home stereo projector with 360-degree rotation, comprising: a base 1, wherein the upper end of the base 1 is fixedly connected to a rotating device 2; the upper end of the rotating device 2 is coupled with a projector body 3; the projector body 3 is provided with a heat dissipating device 4; the projector body 3 is screwed with a dustproof device 5; the outer surface of the projector body 3 is fixedly connected with an illumination lamp 6,
wherein the rotating device 2 includes a support column 21, a box body 22, a rotating shaft 29, a support plate 210, a magnet column 211, a through slot 212, a plug-in board 213, a motor 214, a first bevel gear 215, a second bevel gear 216, a limiting seat 217 and a limiting strip 218; the upper end of the support column 21 is fixedly connected with a box body 22; the box body 22 is provided with a through slot 2121; the through slot 212 is slidably connected to the rotating shaft 29; the plug-in board 213 is slidably inserted into the box body 22; the motor 214 is fixedly connected in the box body 22; the end of the shaft of the motor 214 is fixedly connected to the first bevel gear 215; the first bevel gear 215 is engaged with the second bevel gear 216; the second bevel gear 216 is slidably coupled to the limiting seat 217,
wherein the heat dissipating device 4 includes a cover plate 41, a fan 42, a ventilation tube 43, a support ring 44, a second spring 45, and a sliding sleeve 46; the cover plate 41 is fastened to the projector body 3 by a screw, and the fan 42 is fixedly connected to the lower end of the cover plate 41; the ventilation tube 43 is fixedly connected to the left end of the fan 42, and a support ring 44 is sleeved on the outer side of the ventilation tube 43; the outer side of the ventilation tube 43 is sleeved with a second spring 45, and the outer side of the ventilation tube 43 is sleeved with a sliding sleeve 46; the sliding sleeve 46 is slidably sleeved with the projector body 3,
wherein the dustproof device 5 includes a cylinder body 51, a ventilation opening 52, a card slot 53, a latch 54, a third spring 55, a connecting rod 56, a support piece 57 and a high-efficiency filter net 58; the cylinder body 51 is screwed to the projector body 3 by threads; the cylinder body 51 is provided with the ventilation opening 52, the cylinder body 51 is provided with the card slot 53, the latch 54 is snapped into the card slot 53; the third spring 55 is sleeved on an outer side of the latch 54.

2. The indoor intelligent home stereo projector with 360-degree rotation of claim 1, wherein the rotating shaft 29 is slidably sleeved with the second bevel gear 216; the rotating shaft 29 is provided with a limiting strip 218; the limiting strip 218 is slidably sleeved with the second bevel gear 216; the upper end of the rotating shaft 29 is fixedly connected with a support plate 210; the magnet column 211 is fixedly connected to the upper end of the support plate 210.

3. The indoor intelligent home stereo projector with 360-degree rotation of claim 1, wherein the latch 54 is slidably sleeved with the connecting rod 56, and a support piece 57 is fixedly connected to the right end of the connecting rod 56; the support piece 57 is a porous hollow structure, and the high-efficiency filter net 58 is attached to the left end of the support piece 57.

4. The indoor intelligent home stereo projector with 360-degree rotation of claim 1, wherein the projector body 3 is provided with a ventilation hole 31, and the lower end of the projector body 3 is provided with a positioning slot 32; the positioning slot 32 is slidably connected with the magnet column 211, and the positioning slot 32 is fixedly embedded with an iron block 33; the iron block 33 is attracted to the magnet column 211.

5. The indoor intelligent home stereo projector with 360-degree rotation of claim 1, wherein the projector body 3 is provided with a projection system; the projection system includes a light source, an optical path system, a digital micromirror system, a control system and a power module; the light source is an LED light source, and the control system includes a processor circuit, a digital image driving circuit and an interface circuit; a signal port of the interface circuit is electrically connected to a signal port of the processor circuit, and a signal input end of the digital image driving circuit is electrically connected to a signal output end of the processor circuit; the light source and the signal input of the digital micromirror system are electrically connected to the signal output of the digital image driving circuit.

6. The indoor intelligent home stereo projector with 360-degree rotation of claim 5, wherein the interface circuit includes a WIFI module, an HDMI interface, a USB interface, and a decoding circuit.

7. The indoor intelligent home stereo projector with 360-degree rotation of claim 5, wherein the data port of the processor circuit is connected to the data port of the storage module, and the storage module includes an eMMC memory and a micro SD interface; the data port of the processor circuit is connected to the signal input end of the speaker.
